(19) United States
(12) Patent Application Publication
(10) Pub. No.: US 2010/0122297 A1
(43) Pub. Date: May 13, 2010

(54) SYSTEM AND METHOD FOR USER LIKES MODELING

(75) Inventors: Sridhar Varadarajan, Bangalore (IN); Amit Thawani, Bangalore (IN); Kamakhya Prasad Gupta, Bangalore (IN)

Correspondence Address: VENABLE LLP, P.O. BOX 34385, WASHINGTON, DC, 20043-9998, US

(73) Assignee: SATYAM COMPUTER SERVICES LIMITED, Secunderabad (IN)

(21) Appl. No.: 12/270,465

(22) Filed: Nov. 13, 2008

(51) Int. Cl. H04N 5/445

(52) U.S. Cl. 725/46

(57) ABSTRACT

Modeling user likes and dislikes is an important aspect of target marketing. Typically, a user performs several activities related to a particular domain, and the outcomes of these activities indicate the extent of liking/disliking that resulted on account of these activities. Further, many of these activities are performed on a routine basis. The problem of user likes modeling is to analyze these various activities performed by the user and the solution is to arrive at a likes/dislikes model of the user. Such a likes/dislikes model helps in, for example, ad targeting in the context of TV viewing and cross-selling in the case of mobile services.

### FIELD OF THE INVENTION

The present invention relates to usage analysis in general and more particularly, the analysis of a plurality of activities performed by a user. Still more particularly, the present invention is related to a system and method for the analysis of activities related to a particular domain such as TV viewing.

### BACKGROUND OF THE INVENTION

Users perform a variety of activities routinely on day-to-day basis. The performing of an activity by a user results in whether the user liked or disliked the outcome of the activity. Consider TV viewing scenario. The user, for example, may browse the channels before settling on a particular channel to watch the same for a particular period of time. In this scenario, a way to define the liking would be based on the amount viewing time. In other words, in the case of TV viewing, the user tunes into a particular channel and watching the program currently on air for a particular period of time. This viewing for a period of time indicates the extent of the user's liking towards the program in that particular channel. Observe that this notion of liking brings out implicit liking rather the liking explicitly expressed by the user, and the user liking model based on this notion is quite valuable for many practical applications. One of the important applications of user likes modeling, in the case of TV scenario, is ad targeting. In this application, the user likes model is used to predict the likely channel/program that would be viewed by the user. Even if there is a difference between the prediction and reality (that is, the actual channel/program being viewed by the user), it may be more appropriate to target ads based on the model rather than the current content being viewed. Specifically, the model indicates what is being liked and current view information indicates what is being watched. In such a situation, ad targeting can happen at three levels: level1—targeting based on both model and current view information; level2—targeting based on model (ignoring the current view information); and level3—targeting based on current view information (ignoring the model based information). The ad targeting system can select an ad based on an appropriately selected level. For example, if the current view information is related to a very specific special event such as Olympic games, then it may be more appropriate to target ads at level3. The present invention addresses the issues of building a user likes model based on a plurality of activities performed by a user over a period of time.

### DESCRIPTION OF RELATED ART

U.S. Pat. No. 7,146,627 to Ismail; Labeeb K. (Fremont, Calif.), Gogoi; Amar N. (Fremont, Calif.), Mehta; Manu (Fremont, Calif.) for “Method and apparatus for delivery of targeted video programming” (issued on Dec. 5, 2006 and assigned to Metabyte Networks, Inc. (Fremont, Calif.)) describes a system, residing preferably in a television set-top box, that monitors the television watching habits of one or more viewers, creates one or more profiles for each viewers descriptive of various characteristics of each viewers, including television watching preferences and demographics, and creates a customized and/or targeted video programs for delivery to the viewer or viewers as a linear program.

U.S. Pat. No. 6,934,964 to Schaffer; J. David (Wappingers Falls, N.Y.), Lee; Kwok Pun (Yorktown Heights, N.Y.) for “Electronic program guide viewing history generator method and system” (issued on Aug. 23, 2005 and assigned to Koninklijke Philips Electronics N.V. (Eindhoven, NL) describes an electronic programming guide system that employs a preference engine and processing system and that learns viewers' television watching preferences by monitoring their viewing patterns.

U.S. Pat. No. 6,005,597 to Barrett; David S. (Needham, Mass.), Lee; Gillian M. (Cambridge, Mass.), Miller; Scott N. (Winchester, Mass.), Simpson; M. O. S. C. Jasba (Cambridge, Mass.), Rosenthal; Eric D. (Freehold, N.J.) for “Method and apparatus for program selection” (issued on Dec. 21, 1999 and assigned to Disney Enterprises, Inc. (Burbank, Calif.)) describes a method and apparatus for television program selection that monitors the viewing preferences of a viewer to create a dynamic viewer profile that is used to rate available programs

U.S. Pat. No. 5,801,747 to Bedard; Karen (San Jose, Calif.) for “Method and apparatus for creating a television viewer profile” (issued on Sep. 1, 1998 and assigned to Hyundai Electronics America (San Jose, Calif.)) describes a method and apparatus for monitoring television viewing activity to determine preferred categories of programming and preferred channels of a viewer.

“System and Method for Remote Usage Modeling” by Sridhar Varadarajan, Amit Thawani, and Kamakhya Prasad Gupta, (pending USPTO patent application and assigned to Satyam Computer Services Ltd.) describes a system and method for the modeling of a remote usage that involves the use of both pre-defined models and discovered models. Specifically, a pattern of usage of a remote control unit is abstracted to be one of either a pre-defined model or a discovered model. The model discovery involves the process of generalization based on a set of particular remote control unit usage patterns.

“A Target Advertisement System based on TV Viewer's Profile Reasoning” by Lim, J., Kim, M., Lee, B., Kim; Munchurl, Lee, H., Lee; Han-Kyu (appeared in Multimedia Tools and Applications, Vol. 36, Issue 1-2 (January 2008), Pages: 11-35) describes a user profile reasoning method for TV viewers, wherein the user profile reasoning is made in terms of genre preference and TV viewing times for TV viewer's groups in different genders and ages. For user profiling reasoning, the TV viewing history data is used to train the proposed user profiling reasoning algorithm which allows for target advertisement for different age/gender groups

“A Statistical Model for User Preference” by Jung, S., Hong, J., and Kim, T. (appeared in IEEE Transactions on Knowledge and Data Engineering, Vol. 17, No. 6, June 2005) presents a preference model using mutual information in a statistical framework and a method that combines information of joint features that alleviates problems arising from sparse data.

“Personalized Recommendation of TV Programs” by Ardissono, L. Gena, C., Torasso, P., Bellifemine, F., Chiarotto, A., Difino, A., and Negro, B. (appeared in Proceedings of 8th Congress of the Italian Association for Artificial Intelligence, Pisa, Italy, Sep. 23-26, 2003, Lecture Notes for Artificial Intelligence (AI*IA 2003: Advances in Artificial Intelligence), Springer Verlag) describes recommendation techniques based on integration of heterogeneous user modeling approaches. The personalized recommendation of programs is based on the integration of user modeling techniques relying on explicit user preferences, stereotypical information about TV viewer preferences, and the unobtrusive observation of the user's viewing habits.

“A Fuzzy Linguistic Summarization Technique for TV Recommender Systems” by Pigeau, A., Raschia, G., Gelgon, M., Mouaddib, N., and Saint-Paul, R. (appeared in Proceedings of the 12th IEEE International Conference on Fuzzy Systems, 2003. FUZZ apos'03, Vol. 1, 25-28 May 2003) presents a TV recommender system using fuzzy linguistic summarization technique which enables automatic learning of the user profile.

The known systems do not address the various issues related to the user likes modeling based on a plurality of activities specific to a user related to a particular domain from multiple perspectives in order to be able to predict the expected user behavior. The present invention provides a system and method to effectively analyze a plurality of activities of the user to build the user likes model.

### SUMMARY OF THE INVENTION

The primary objective of the invention is to analyze a plurality of activities of a user from a plurality of perspectives in order to arrive at a user's likes model.

One aspect of the system is to perform the analysis of a user data from a perspective of the channels tuned.

Yet another aspect of the system is to perform the analysis of a user data from a perspective of the programs viewed.

Another aspect of the invention is to perform combined analysis based on channel tune analysis and program view analysis to arrive a user likes model.

Yet another aspect of the invention is to adapt a user likes model based on the actual channels tuned and the actual programs viewed.

Another aspect of the invention is to define the channel tune data as a matrix based on a plurality of slots and a plurality of channels.

Yet another aspect of the invention is to define an abstract channel tune data matrix based on a plurality of meta-slots and a plurality of meta-channels, wherein a meta-slot is a subset of a plurality of slots and a meta-channel is a subset of a plurality of channels.

Another aspect of the invention is to define a transformation on a channel tune data matrix so as to arrive at a better characterization of the channel tune data matrix.

Another aspect of the invention is to define the program view data as a matrix based on a plurality of slots and a plurality of programs.

Yet another aspect of the invention is to define an abstract program view data matrix based on a plurality of meta-slots and a plurality of meta-programs, wherein a meta-slot is a subset of a plurality of slots and a meta-program is a subset of a plurality of programs.

Another aspect of the invention is to define a transformation on a program view data matrix so as to arrive at a better characterization of the program view data matrix.

### BRIEF DESCRIPTION OF THE DRAWINGS

FIG. 1 depicts an illustrative TV/STB scenario.

FIG. 2 depicts an illustrative User Likes Modeling System.

FIG. 3 depicts illustrative representations of a session.

FIG. 4 depicts an illustrative data set.

FIG. 5 provides basic analysis functions.

FIG. 6 provides an approach for channel tune local analysis.

FIG. 6a provides an approach for channel tune global analysis.

FIG. 7 provides an approach for program view local analysis.

FIG. 7a provides an approach for program view global analysis.

FIG. 8 provides an approach for combined analysis.

FIG. 9 provides an approach for adapting a user likes model.

FIG. 10 depicts illustrative results.

FIG. 10a depicts additional illustrative results.

### DETAILED DESCRIPTION OF THE PREFERRED EMBODIMENTS

Consider the scenario of TV viewing: a common scenario involves a user switching on a TV, browsing and tuning onto a channel, viewing the program that is being shown in the tuned channel, tuning to a new channel, watching the program in that channel, and so on, until the TV is switched off. Specifically, there are two distinct kinds of activities performed by the user: tuning of a channel and viewing of a program. Monitoring and analyzing of these kinds of user activities help in building a user likes model that depicts the channels liked by the user and the programs liked by the user. Such a model of the user is useful in applications such as content targeting in general and ad targeting in particular.

The modeling based on user activities' data involves analyzing of data related to channels tuned and programs viewed. The channel tuned data analysis involves depicting the data as a matrix containing the channels tuned at various time intervals. In order to bring in homogeneity in the analysis across the activities performed over a period of time, the time intervals are divided into slots of fixed time duration, say, each slot of thirty minutes duration. Similarly, the programs viewed is analyzed with respect to these fixed duration slots. Both channel data analysis and program data analysis involves processing of a stack of matrices in two parts: local analysis of a single matrix (that is data related to the activities during a particular day), and global analysis of the locally analyzed matrices. The next step in the building of a user likes model is to combine the results of the analysis of channel data matrices and program data matrices. This combining provides a further insight into a program liked by the user in a particular channel. Finally, in order to do effective targeting, it is useful to adapt the determined user likes model based on the variance in the predicted channels and programs, and the actual channels tuned and programs viewed.

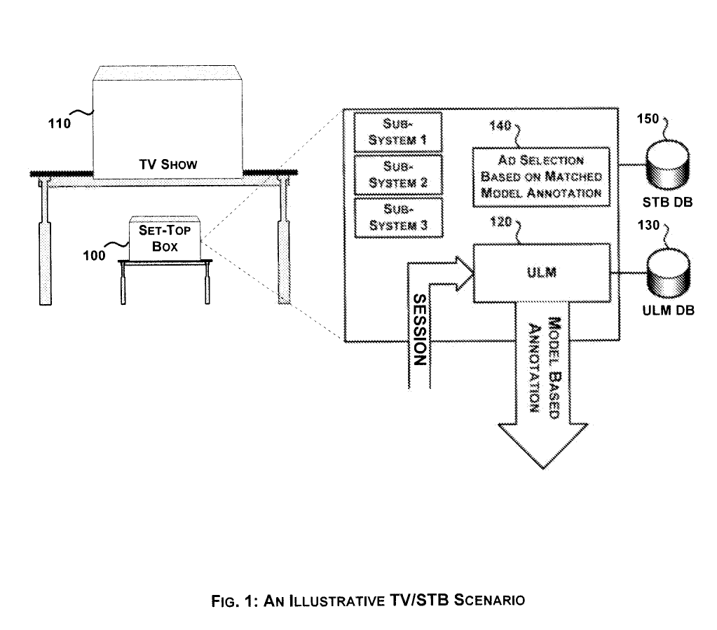

FIG. 1 depicts an illustrative TV/STB scenario. In this scenario, a set-top box (STB) (100) connected to a TV (110) is used to control the functionality of a television. A typical STB supports various functionalities that include the receiving and displaying of the selected channel contents. One of the important functionalities is to support ULM (120) that makes use of a database (130) to help monitor user's activities to collect channels tuned data and programs viewed data. In particular, ULM subsystem analyzes the user activities to adapt the user likes model to better annotate for effective content targeting. This annotation is used by another subsystem (140) to help select appropriate ads based on an STB database (150).

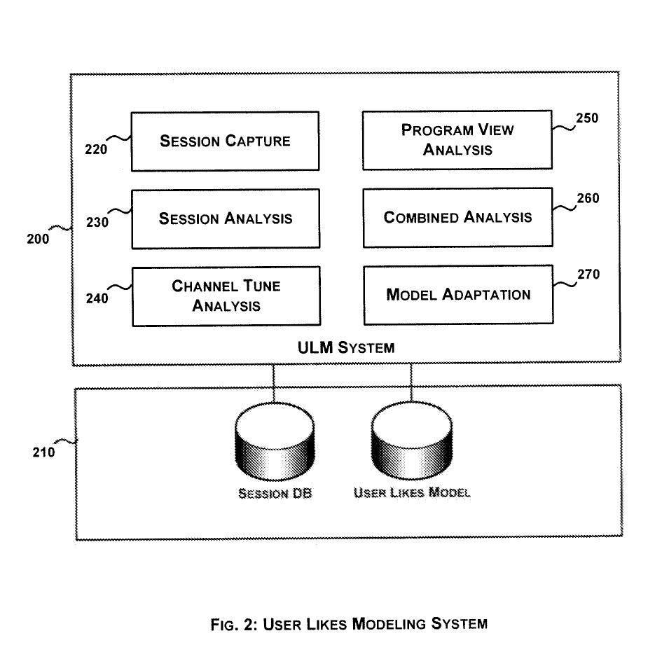

FIG. 2 depicts an illustrative User Likes Modeling System. The ULM system (200) comprises of a variety of modules to help capture, analyze, and label a session. Here, the session refers to the activities performed by a user between, say, power on and power off of a television. The database (210) consists of Session database to provide information related to the various activities performed by a user, and the user likes model database contains the built model and adapted version of the user likes model based on actual session data. The main modules of ULM are: Session Capture (220) that obtains session-specific usage data from a database; Session Analysis (230) analyzes the captured session-specific usage data and prepares for further processing; Channel Tune Analysis (240) module analyzes the session data from channels perspective in order to build channel likes model; Program View Analysis (250) similarly analyzes the session data from programs perspective in order to build program likes model; Combined Analysis (260) combines the channel and program likes models to build a user likes model; Finally, Model Adaption (270) analyzes the past activities data and the user likes model to adapt the same to reduce variance with respect to the actual data.

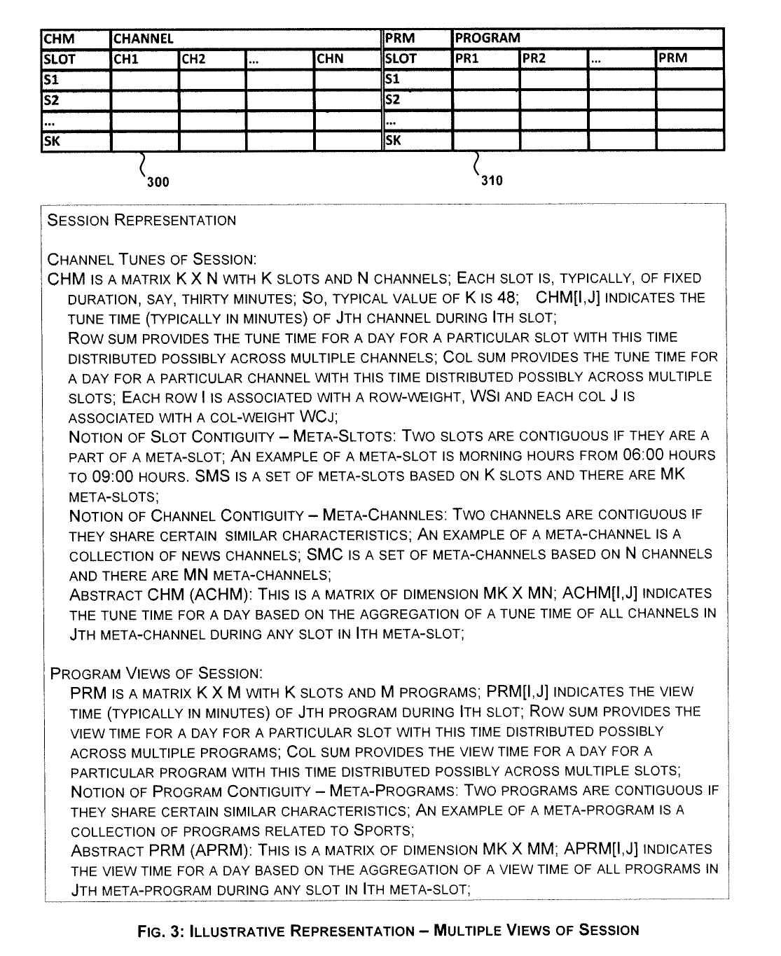

FIG. 3 depicts illustrative representations of a session. A session denotes a sequence of user activities between power on and power off of a television. Two activities of interest are tuning of a particular channel and viewing of a particular program. CHM (300) denotes a matrix of slots and channels, and PRM (310) denotes a matrix of slots and programs, and these two matrices together capture the activities of a user. A slot denotes a time interval that is fixed in duration and typically, the slots are of equal duration (say, thirty minutes).

### Channel Tunes of Session:

CHM is a matrix K×N with K slots and N channels; Each slot is, typically, of fixed duration, say, thirty minutes; So, typical value of K is 48; CHM[I,J] indicates the tune time (typically in minutes) of Jth channel during Ith slot;
Row sum provides the tune time for a day for a particular slot with this time distributed possibly across multiple channels; Col sum provides the tune time for a day for a particular channel with this time distributed possibly across multiple slots; Each row I is associated with a row-weight, WSi and each col J is associated with a col-weight WCj;
Notion of Slot Contiguity—Meta-Slots: Two slots are contiguous if they are a part of a meta-slot; An example of a meta-slot is morning hours from 06:00 hours to 09:00 hours. SMS is a set of meta-slots based on K slots and there are MK meta-slots;
Notion of Channel Contiguity—Meta-Channels: Two channels are contiguous if they share certain similar characteristics; An example of a meta-channel is a collection of news channels; SMC is a set of meta-channels based on N channels and there are MN meta-channels;
Abstract CHM (ACHM): This is a matrix of dimension MK×MN; ACHM[I,J] indicates the tune time for a day based on the aggregation of a tune time of all channels in Jth meta-channel during any slot in Ith meta-slot;

### Program Views of Session:

PRM is a matrix K×M with K slots and M programs; PRM[I,J] indicates the view time (typically in minutes) of Jth program during Ith slot; Row sum provides the view time for a day for a particular slot with this time distributed possibly across multiple programs; Col sum provides the view time for a day for a particular program with this time distributed possibly across multiple slots;
Notion of Program Contiguity—Meta-Programs: Two programs are contiguous if they share certain similar characteristics; An example of a meta-program is a collection of programs related to Sports;
Abstract PRM (APRM): This is a matrix of dimension MK×MM; APRM[I,J] indicates the view time for a day based on the aggregation of a view time of all programs in Jth meta-program during any slot in Ith meta-slot;

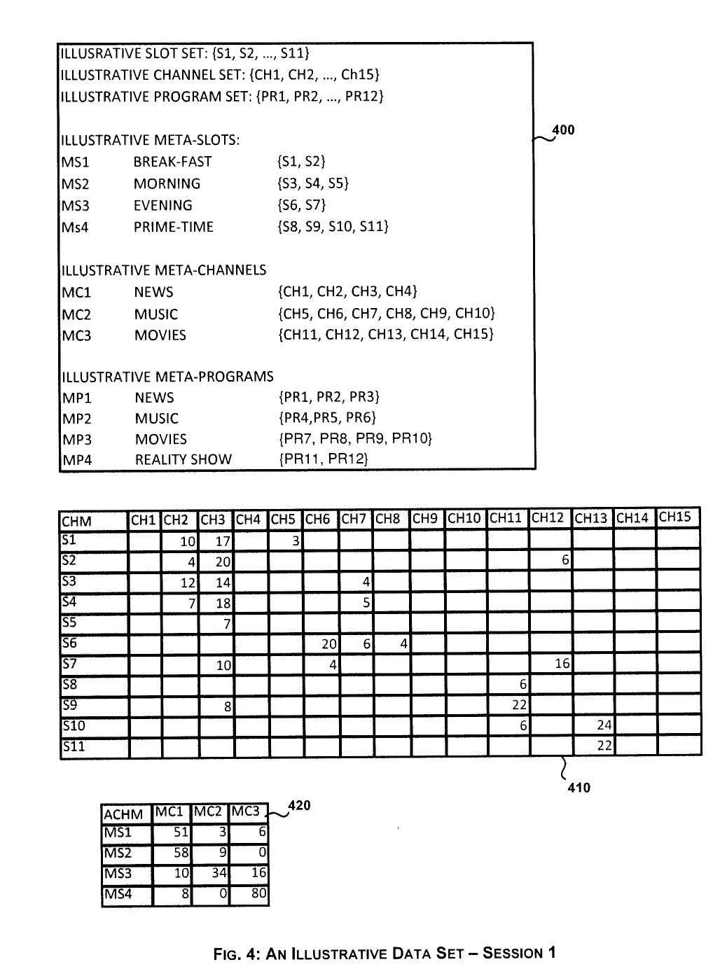

FIG. 4 depicts an illustrative data set. The provided illustrative data set includes slots, channels, programs, meta-slots, meta-channels, and meta-programs (400). An illustrative CHM is a 15×11 matrix depicting the channels tuned in different slots. For example, CHM[1,2] indicates the tuning of channel CH2 for a period of 10 minutes during slot S1. An abstract version of CHM that is based on meta-channels and meta-slots is a 4×3 matrix involving four meta-slots and three meta-channels (420).

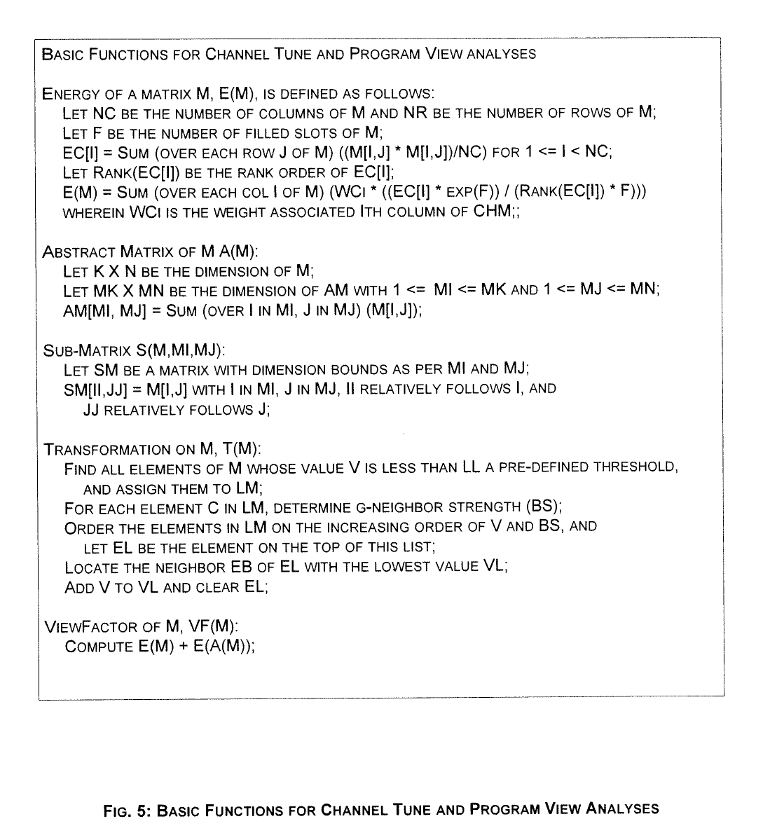

FIG. 5 provides basic analysis functions. These functions are used as part of channel tune and program view analyses.

Energy of a matrix M, E(M), is defined as follows:
Let NC be the number of columns of M and NR be the number of rows of M;
Let F be the number of filled slots of M;
EC[I]=Sum (over each row J of M) ((M[I,J]*M[I,J])/NC) for 1<=I<NC;
Let Rank(EC[I]) be the rank order of EC[I];
E(M)=Sum (over each col I of M) (WCi*((EC[I]*exp(F))/(Rank(EC[I])*F)))
wherein WCi is the weight associated with the Ith column of CHM;

### Abstract Matrix of M A(M):

Let K×N be the dimension of M;
Let MK×MN be the dimension of AM with 1<=MI<=MK and 1<=MJ<=MN;
AM[MI, MJ]=Sum (over I in MI, J in MJ) (M[I,J]);

Note that AM is a matrix based on meta-slots and meta-channels/meta-programs. The indices I and MI are related based on slot and meta-slot relationship, and similarly is the relationship between J and MJ;

### Sub-Matrix S(M,MI,MJ):

Let SM be a matrix with dimension bounds as per MI and MJ;
SM[II,JJ]=M[I,J] with I in MI, J in MJ, II relatively follows I, and
   JJ relatively follows J;

Note that a sub-matrix is defined based on the notion of meta-slot and meta-channel/meta-program. That is, MI is an index into a meta-slot, and the meta-slot defines a set of slots; I in MI indicates the index into M such that the corresponding slot is a part of the meta-slot related to the index MI. Similarly is the notion of J in MJ.

### Transformation on M, T(M):

Find all elements of M whose value V is less than LL a pre-defined threshold, and assign them to LM;
For each element C in LM, determine g-neighbor strength (BS);
Order the elements in LM on the increasing order of V and BS, and
   let EL be the element on the top of this list;
Locate the neighbor EB of EL with the lowest value VL;
Add V to VL and clear EL;

An example of g-neighbor strength is the computation of neighbor strengths based on 8 neighbors.

### ViewFactor of M, VF(M):

Compute E(M)+E(A(M));

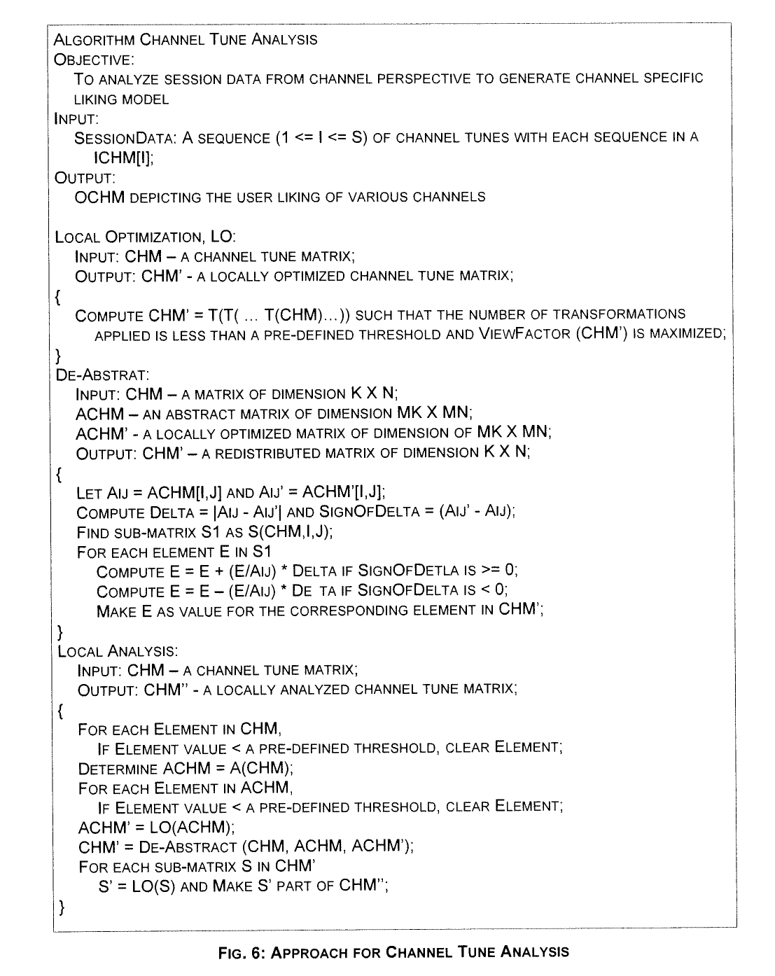

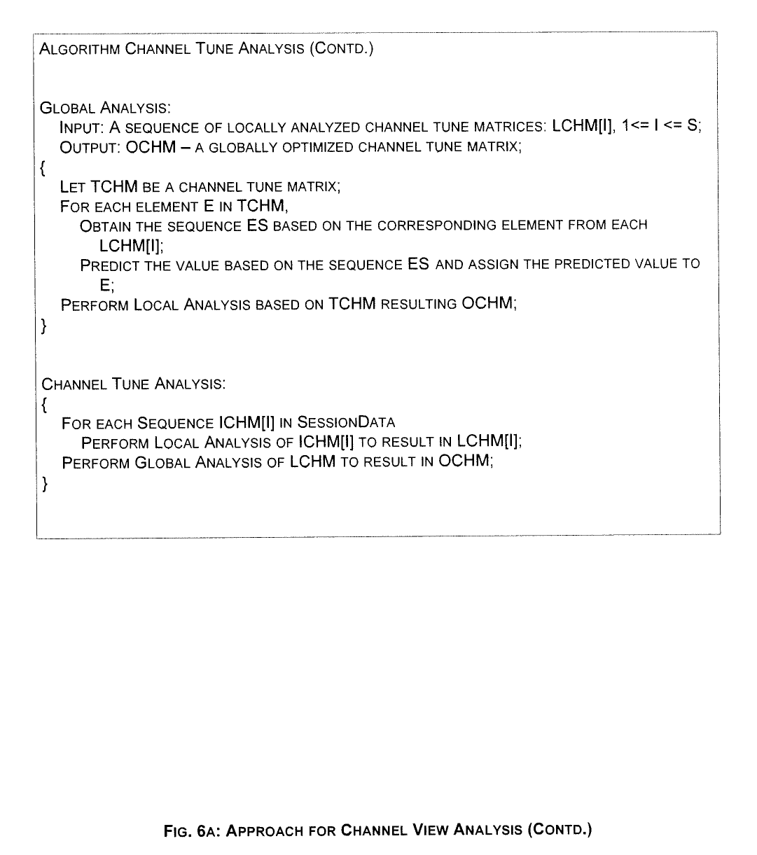

FIG. 6 provides an approach for channel tune local analysis.

The main objective of the algorithm Channel Tune Analysis is to analyze session data from channel perspective to generate channel specific liking model

### Input:

SessionData: A sequence (1<=I<=S) of channel tunes with each sequence in a ICHM[I];

### Output:

OCHM depicting the user liking of various channels

### Local Optimization, LO:

```
  Input: CHM - a channel tune matrix;
  Output: CHM’ - a locally optimized channel tune matrix;
{
  Compute CHM’ = T(T( ... T(CHM)...)) such that the number of
    transformations applied is less than a pre-defined threshold and
    ViewFactor (CHM’) is maximized;
}
```

Note that the local optimization involves applying of a sequence of transformations, wherein each transformation involves combining of neighbors so as to arrive at a characterization of the channel tune matrix. Note that typically, a channel tune matrix is a sparse matrix defying any direct abstraction and the sequence of transformations help manage the abstraction without much logically disturbing the original channel tune data.

### De-Abstrat:

```
  Input: CHM - a matrix of dimension K × N;
  ACHM - an abstract matrix of dimension MK × MN;
  ACHM’ - a locally optimized matrix of dimension of MK × MN;
  Output: CHM’ - a redistributed matrix of dimension K × N;
{
  Let Aij = ACHM[I,J] and Aij’ = ACHM’[I,J];
  Compute Delta = |Aij − Aij’| and SignOfDelta = (Aij’ − Aij);
  Find sub-matrix S1 as S(ACHM’,I,J);
  For each element E in S1
    Compute E = E + (E/Aij ) * Delta if SignOfDetla is >= 0;
    Compute E = E − (E/Aij) * Delta if SignOfDelta is < 0;
    Make E as value for the corresponding element in CHM’;
}
```

In order to minimize the disturbing of the original channel tune data, typically, the transformations are performed on an abstract matrix. Hence, after the local optimization that applies a sequence of transformations, it is necessary to remap the abstract matrix back to the original channel tune matrix. This redistribution is based on the quantum of change in the abstract matrix ACHM′ as compared with ACHM, and apportioning this change (positively or negatively) among the elements of the corresponding CHM (based on slot/meta-slot, and channel/meta-channel relationships).

### Local Analysis:

```
  Input: CHM - a channel tune matrix;
  Output: CHM” - a locally analyzed channel tune matrix;
{
  For each Element in CHM,
    If Element value < a pre-defined threshold, clear Element;
  Determine ACHM = A(CHM);
  For each Element in ACHM,
    If Element value < a pre-defined threshold, clear Element;
  ACHM’ = LO(ACHM);
  CHM’ = De-Abstract (CHM, ACHM, ACHM’);
  For each sub-matrix S in CHM’
    S’ = LO(S) and Make S’ part of CHM”;
}
```

Observe that the local analysis is performed on a channel tune matrix in such a way that the resulting CHM″ is both locally optimal and logically plausible (based on slot/meta-slot and channel/meta-channel relationships).

FIG. 6a provides an approach for channel tune global analysis.

### Global Analysis:

```
  Input: A sequence of locally analyzed channel tune matrices:
  LCHM[I], 1<= I <= S;
  Output: OCHM - a globally optimized channel tune matrix;
{
  Let TCHM be a channel tune matrix;
  For each element E in TCHM,
    Obtain the sequence ES based on the corresponding element from
    each LCHM[I];
    Predict the value based on the sequence ES and assign the predicted
    value to E;
  Perform Local Analysis based on TCHM resulting OCHM;
}
```

### Channel Tune Analysis:

```
{
  For each Sequence ICHM[I] in SessionData
    Perform Local Analysis of ICHM[I] to result in LCHM[I];
  Perform Global Analysis of LCHM to result in OCHM;
}
```

Performing local analysis and global analysis in two distinct steps is based on a well-known approach of divide and conquer. A sequence of Channel Tune matrices are first locally analyzed independent of each other, and subsequently combined to arrive at a representative Channel Tune Matrix that is a generalization of the given sequence of Channel Tune matrices. A final local analysis of the representative Channel Tune Matrix results in the near-optimal Channel Likes Model.

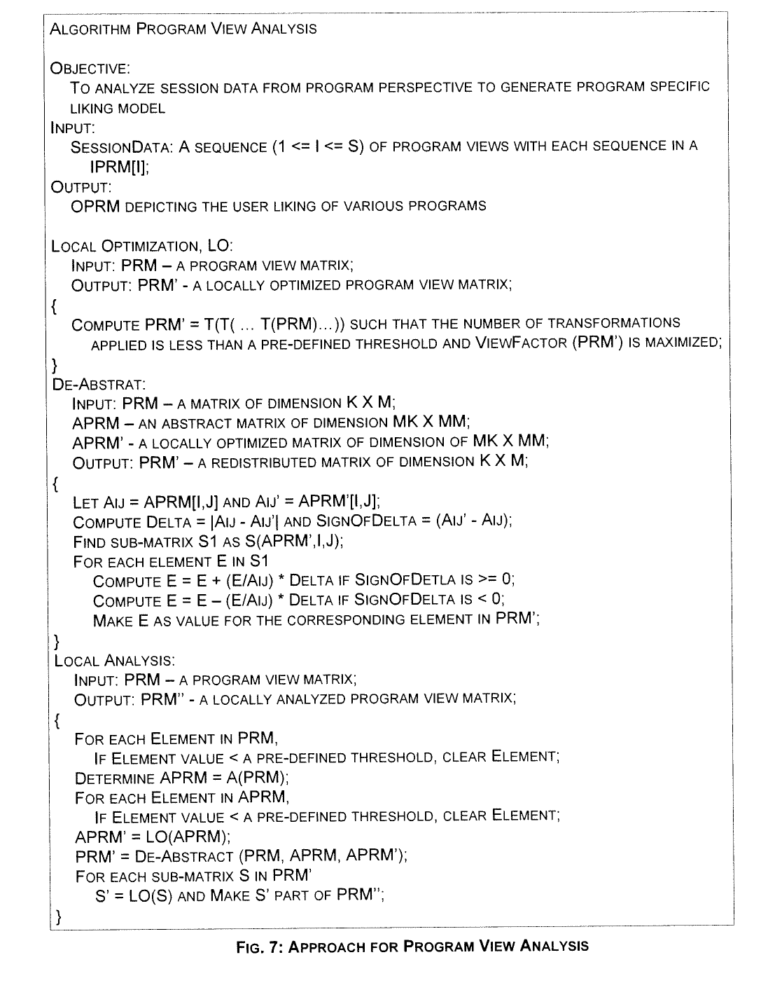

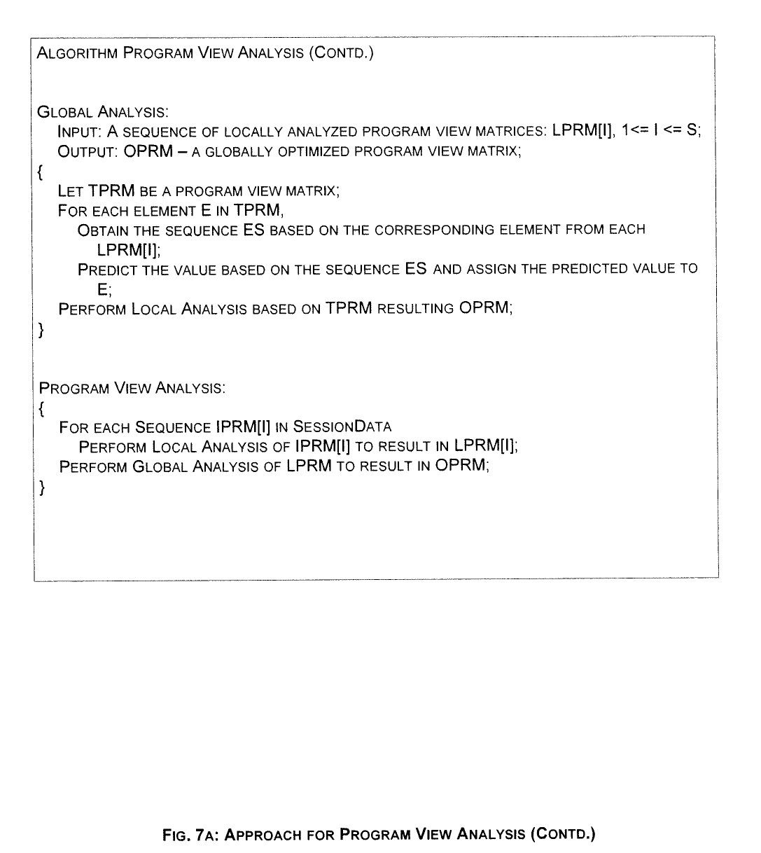

FIG. 7 provides an approach for program view local analysis.

The main objective of the algorithm Program View Analysis is to analyze session data from program perspective to generate program specific liking model. Note that the program view local analysis is similar to the channel tune local analysis.

### Input:

SessionData: A sequence (1<=I<=S) of program views with each sequence in a IPRM[I];

### Output:

OPRM depicting the user liking of various programs

### Local Optimization, LO:

```
  Input: PRM - a program view matrix;
  Output: PRM’ - a locally optimized program view matrix;
{
  Compute PRM’ = T(T( ... T(PRM)...)) such that the number of
  transformations applied is less than a pre-defined threshold and
  ViewFactor (PRM’) is maximized;
}
```

### De-Abstrat:

```
  Input: PRM - a matrix of dimension K × M;
  APRM - an abstract matrix of dimension MK × MM;
  APRM’ - a locally optimized matrix of dimension of MK × MM;
  Output: PRM’ - a redistributed matrix of dimension K × M;
{
  Let Aij = APRM[I,J] and Aij’ = APRM’[I,J];
  Compute Delta = |Aij − Aij’| and SignOfDelta = (Aij’ − Aij);
  Find sub-matrix S1 as S(APRM’,I,J);
  For each element E in S1
    Compute E = E + (E/Aij ) * Delta if SignOfDetla is >= 0;
    Compute E = E − (E/Aij) * Delta if SignOfDelta is < 0;
    Make E as value for the corresponding element in PRM’;
}
```

### Local Analysis:

```
  Input: PRM - a program view matrix;
  Output: PRM” - a locally analyzed program view matrix;
{
  For each Element in PRM,
    If Element value < a pre-defined threshold, clear Element;
  Determine APRM = A(PRM);
  For each Element in APRM,
    If Element value < a pre-defined threshold, clear Element;
  APRM’ = LO(APRM);
  PRM’ = De-Abstract (PRM, APRM, APRM’);
  For each sub-matrix S in PRM’
    S’ = LO(S) and Make S’ part of PRM”;
}
```

FIG. 7a provides an approach for program view global analysis. Note that the program view global analysis is similar to the channel tune global analysis.

### Global Analysis:

```
  Input: A sequence of locally analyzed program view matrices:
  LPRM[I], 1<= I <= S;
  Output: OPRM - a globally optimized program view matrix;
{
  Let TPRM be a program view matrix;
  For each element E in TPRM,
    Obtain the sequence ES based on the corresponding element from
    each LPRM[I];
    Predict the value based on the sequence ES and assign the predicted
    value to E;
  Perform Local Analysis based on TPRM resulting OPRM;
}
```

### Program View Analysis:

```
{
  For each Sequence IPRM[I] in SessionData
    Perform Local Analysis of IPRM[I] to result in LPRM[I];
  Perform Global Analysis of LPRM to result in OPRM;
}
```

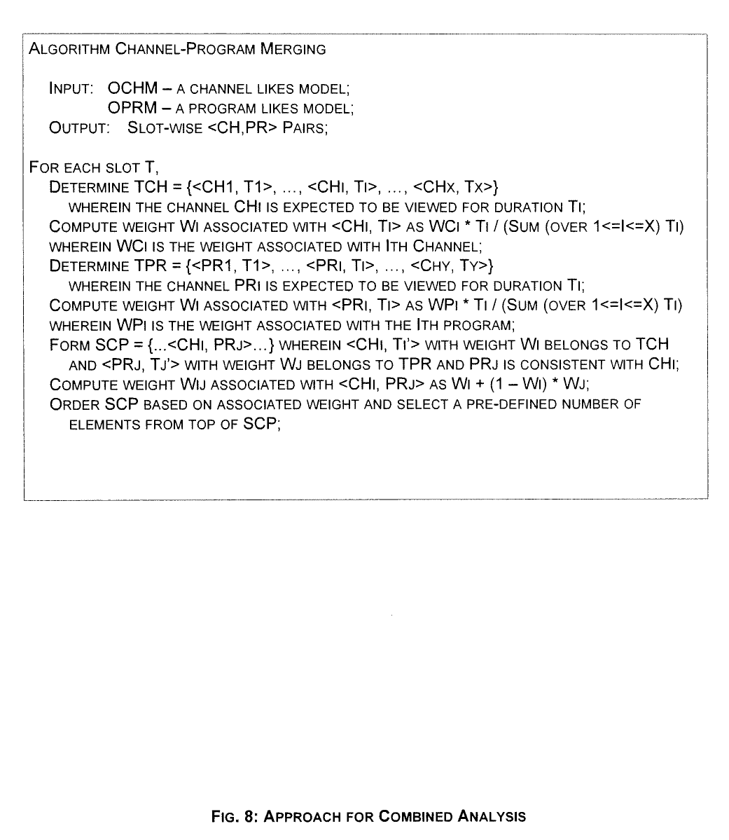

FIG. 8 provides an approach for combined analysis. The objective of the algorithm Channel-Program Merging is to arrive at the best possible channel-program pairs for each of the slots.

Input: OCHM—a channel likes model;
OPRM—a program likes model;

### Output: Slot-wise <CH,PR> Pairs;

For each slot T,
Determine TCH={<CH1, T1>, . . . , <CHi, Ti>, . . . , <CHx, Tx>}
   wherein the channel CHi is expected to be viewed for duration Ti;
Compute weight Wi associated with <CHi, Ti> as
WCi*Ti/(Sum (over 1<=I<=X) Ti) wherein WCi is the weight associated with Ith Channel;
Determine TPR={<PR1, T1>, . . . , <PRi, Ti>, . . . , <Chy, Ty>}
   wherein the channel PRi is expected to be viewed for duration Ti;
Compute weight Wi associated with <PRi, Ti> as
WPi*Ti/(Sum (over 1<=I<=X) Ti) wherein WPi is the weight associated with the Ith program;
Form SCP={ . . . <CHi, PRj> . . . } wherein <CHi, Ti′> with weight Wi belongs to TCH and <PRj, Tj′> with weight Wj belongs to TPR, and PRj is consistent with CHi;
Compute weight Wij associated with <CHi, PRj> as Wi+(1−Wi)*Wj;
Order SCP based on associated weight and select a pre-defined number of elements from top of SCP;

Note that the selected channel-programs are consistent given the characteristics of a channel and a program. The selected <CH, PR> pairs depicts the most likely tuned channels and the most likely viewed programs for a given slot.

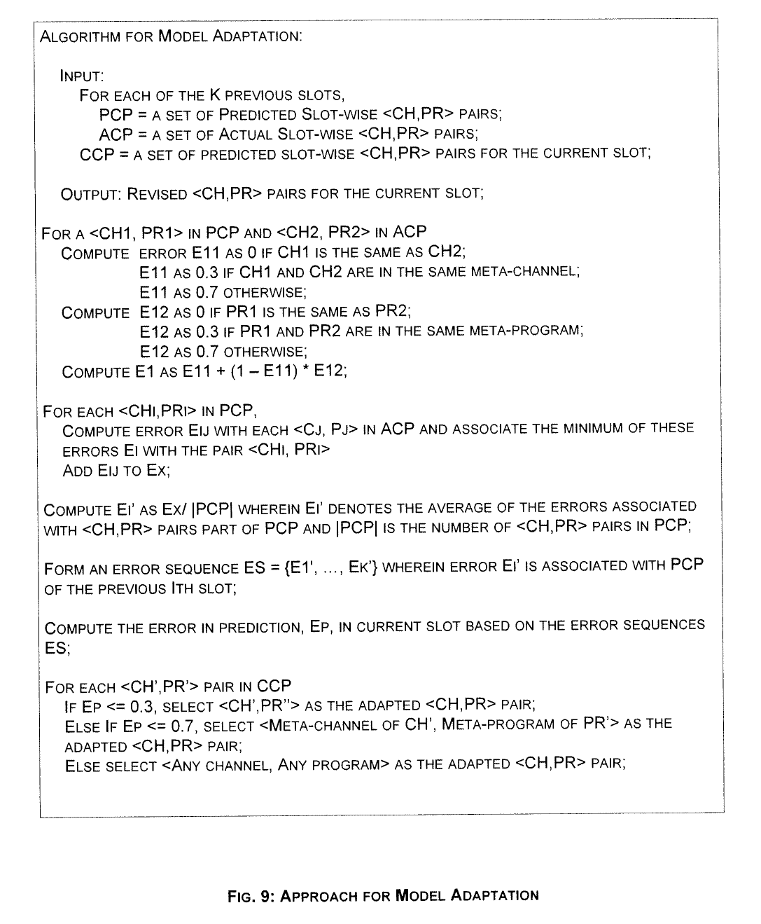

FIG. 9 provides an approach for adapting a user likes model. The objective of the algorithm is to adapt the slot-wise <CH, PR> pairs based on actual and predicted data over the last K slots.
Input:
   For each of the K previous slots,
      PCP=a set of Predicted Slot-wise <CH,PR> pairs;
      ACP=a set of Actual Slot-wise <CH,PR> pairs;
   CCP=a set of predicted slot-wise <CH,PR> pairs for the current slot;
Output: Revised <CH,PR> pairs for the current slot;

For a <CH1, PR1> in PCP and <CH2, PR2> in ACP
Compute error E11 as 0 if CH1 is the same as CH2;
   E11 as 0.3 if CH1 and CH2 are in the same meta-channel;
   E11 as 0.7 otherwise;
Compute E12 as 0 if PR1 is the same as PR2;
   E12 as 0.3 if PR1 and PR2 are in the same meta-program;
   E12 as 0.7 otherwise;
Compute E1 as E11+(1−E11)*E12;

For each <CHi,PRi> in PCP,
Compute error Eij with each <Cj, Pj> in ACP and associate the minimum of these errors Ei with the pair <CHi, PRi>
Add Eij to Ex;

Compute Ei′ as Ex/|PCP| wherein Ei′ denotes the average of the errors associated with <CH,PR> pairs part of PCP and |PCP| is the number of <CH,PR> pairs in PCP;

Form an error sequence ES={E1′, . . . , Ek′} wherein error Ei′ is associated with PCP of the previous Ith slot;

Compute the error in prediction, Ep, in current slot based on the error sequences ES;

For each <CH′,PR′> pair in CCP
If Ep<=0.3, select <CH′,PR″> as the adapted <CH,PR> pair;
Else If Ep<=0.7, select <Meta-channel of CH′, Meta-program of PR′> as the adapted <CH,PR> pair;
Else select <Any channel, Any program> as the adapted <CH,PR> pair;

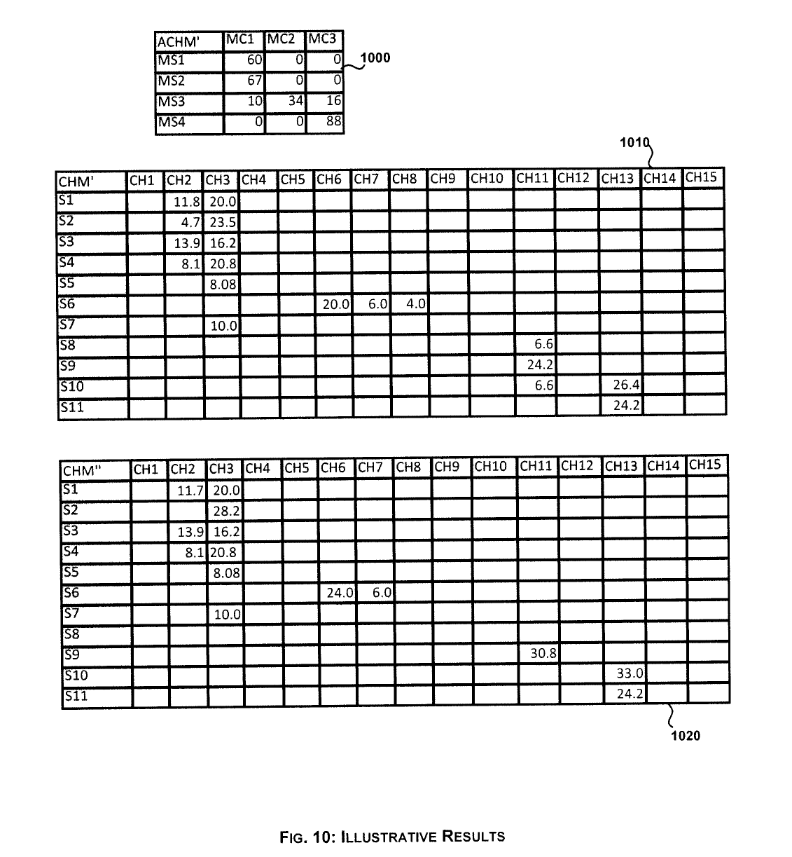

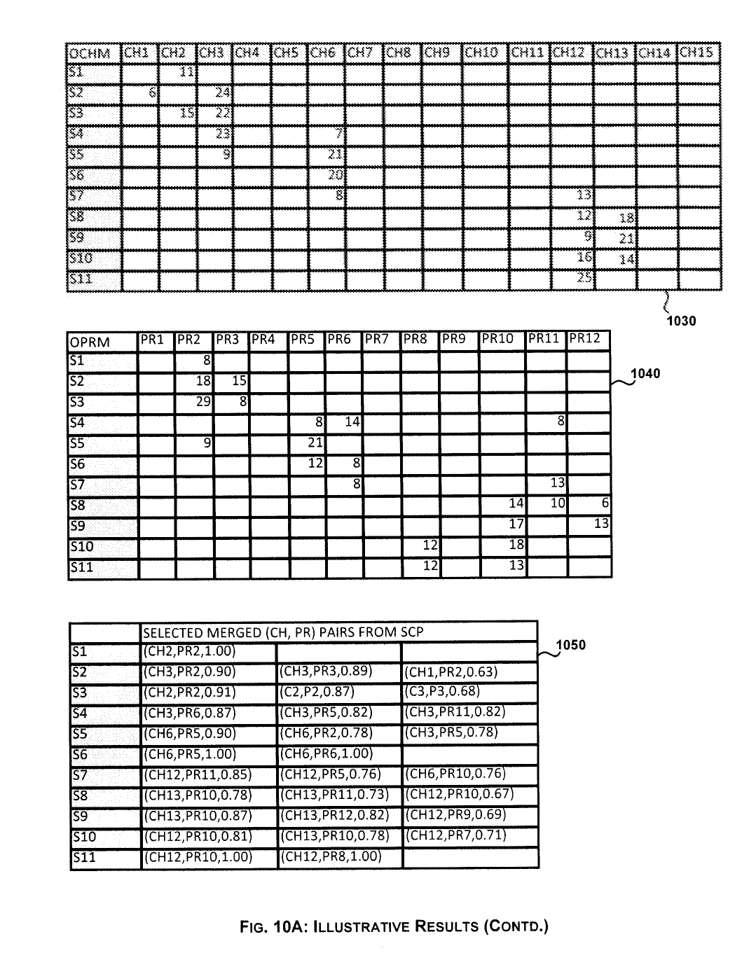

FIG. 10 depicts illustrative results. An illustrative locally optimized abstract matrix ACHM′ based on 420 is depicted in 1000. 1010 depicts de-abstracted CHM′ based on ACHM′ and 1020 depicts locally analyzed CHM″ based on CHM (410).

FIG. 10a depicts additional illustrative results. 1030 depicts an illustrative OCHM based on Channel Tune analysis and 1040 depicts an illustrative OPRM based on Program View analysis. 1050 depicts the results of combined analysis based on OCHM and OPRM. For example, in slot S1, the most likely tuned channel is CH2 with the most likely viewed program being PR2.

Thus, a system and method for user likes modeling is disclosed. Although the present invention has been described particularly with reference to the figures, it will be apparent to one of the ordinary skill in the art that the present invention may appear in any number of systems that identifies an interaction behavior of a user while watching a television. It is further contemplated that many changes and modifications may be made by one of ordinary skill in the art without departing from the spirit and scope of the present invention.

What is claimed is:

1. A method for a likes modeling of a user based on a plurality of activities of said user with respect to an apparatus, wherein said apparatus is capable of being tuned to a plurality of channels and is capable of enabling viewing of a plurality of programs during a plurality of slots, wherein a slot of said plurality of slots is a time interval of fixed duration, said method comprising: obtaining of a plurality of meta-slots, wherein each of said plurality of meta-slots is a subset of said plurality slots, obtaining of a plurality of meta-channels, wherein each of said plurality of meta-channels is a subset of said plurality of channels, obtaining of a plurality of meta-programs, wherein each of said plurality of meta-programs is a subset of said plurality of programs, receiving of a plurality of session data related to said plurality of activities, determining of a plurality of channel tune matrices based on said plurality of session data, determining of a plurality of program view matrices based on said plurality of session data, computing of a globally optimal channel tune matrix based on said plurality of channel tune matrices, computing of a globally optimal program view matrix based on said plurality of program view matrices, computing of a plurality of plurality of selected channel-program pairs based on said globally optimal channel tune matrix and said globally optimal program view matrix, wherein a selected channel-program pair of said plurality of plurality of selected channel-program pairs comprises a channel of said plurality of channels and a program of said plurality of programs, and computing of a plurality of plurality of adapted channel-program pairs based on said plurality of plurality of selected channel-program pairs and a past session data to determine said likes modeling.

2. The method of claim 1, wherein said method of determining of said plurality of channel tune matrices further comprising: obtaining of a session data of said plurality of session data, obtaining of a plurality of channels tuned based on said session data, obtaining of a start time and a time duration associated with a channel tuned of said plurality of channels tuned, determining of a channel tune matrix of said plurality of channel tune matrices, wherein said channel tune matrix is based on said plurality of slots and said plurality of channels, determining of a slot of said plurality of slots based on said start time associated with said channel tuned, determining of a channel of said plurality of channels based on said channel tuned, and making of said time duration part of said channel tune matrix based on said slot and said channel.

3. The method of claim 1, wherein said method of determining of said plurality of program view matrices further comprising: obtaining of a session data of said plurality of session data, obtaining of a plurality of programs viewed based on said session data, obtaining of a start time and a time duration associated with a program viewed of said plurality of programs viewed, determining of a program view matrix of said plurality of program view matrices, wherein said program view matrix is based on said plurality of slots and said plurality of programs, determining of a slot of said plurality of slots based on said start time associated with said program viewed, determining of a program of said plurality of programs based on said program viewed, and making of said time duration part of said program view matrix based on said slot and said program.

4. The method of claim 1, wherein said method of computing of said globally optimal channel tune matrix further comprising: performing of local analysis of each of said plurality of channel tune matrices to result in a plurality of locally analyzed channel tune matrices, and performing of global analysis based on said plurality of locally analyzed channel tune matrices to result in said globally optimal channel tune matrix.

5. The method of claim 4, wherein said method of performing local analysis further comprising: clearing of an element of a channel tune matrix of said plurality of channel tune matrices if the time duration associated with said element is less than a pre-defined threshold, determining of an abstract channel tune matrix based on said channel tune matrix, clearing of an element of said abstract channel tune matrix if the time duration associated with said element is less than a pre-defined threshold, performing of local optimization based on said abstract channel tune matrix resulting in a locally optimized abstract channel tune matrix, de-abstracting of said locally optimized abstract channel tune matrix resulting in a redistributed channel tune matrix, obtaining of a sub-matrix of said redistributed channel tune matrix, wherein said sub-matrix is based on a meta-slot of said plurality of meta-slots and a meta-channel of said plurality of meta-channels, performing of local optimization based on said sub-matrix resulting in a locally optimized sub-matrix, and making of said locally optimized sub-matrix a part of a locally analyzed channel tune matrix of said plurality of locally analyzed channel tune matrices.

6. The method of claim 5, wherein said method of determining of said abstract channel tune matrix further comprising: obtaining of said channel tune matrix, obtaining of an abstract row index of said abstract channel tune matrix, obtaining of an abstract column index of said abstract channel tune matrix, obtaining of a plurality of row indices, wherein each row index of said plurality of row indices is associated with said abstract row index, obtaining of a plurality of column indices, wherein each column index of said plurality of column indices is associated with said abstract column index, computing of a sum of a plurality of elements of said channel tune matrix based on said plurality of row indices and said plurality of column indices, wherein each element of said plurality of elements is part of said channel tune matrix at an element row index and an element column index, wherein said element row index is part of said plurality of row indices and said element column index is part of said plurality of column indices, and making of said sum a part of said abstract channel tune matrix at said abstract row index and said abstract column index.

7. The method of claim 5, wherein said method of local optimization further comprising: obtaining of said abstract channel tune matrix, applying of transformation on said abstract channel tune matrix to result in a transformed channel tune matrix, computing of a view factor of said transformed channel tune matrix, and applying of a sequence of transformations on said transformed channel tune matrix by maximizing on said view factor, wherein said view factor is computed for each transformation of said sequence.

8. The method of claim 7, wherein said method of transformation further comprising: determining of a plurality of elements of said abstract channel tune matrix, wherein the value of each of said plurality of elements is less than a pre-defined threshold, determining of a g-neighbor strength for each of said plurality of elements, obtaining of a minimum element from said plurality of elements based on said value of each of said plurality of elements and g-neighbor strength of each of said plurality of elements, obtaining of a neighbor of said minimum element, wherein the value of said neighbor is the lowest among the neighbors of said minimum element, adding of the value of said minimum element to said neighbor, and clearing of said minimum element.

9. The method of claim 7, wherein said method of computing a view factor further comprising: obtaining of said transformed channel tune matrix, computing energy associated with said transformed channel tune matrix resulting in a first component, obtaining of an abstract channel tune matrix based on said transformed channel tune matrix, computing of energy associated with said abstract channel tune matrix resulting in a second component, and computing of said view factor based on said first component and said second component.

10. The method of claim 9, wherein said method of computing energy of said transformed channel tune matrix further comprising: obtaining of a number of rows of said transformed channel tune matrix, obtaining of a number of columns of said transformed channel tune matrix, obtaining of a number of filled elements of said transformed channel tune matrix, computing of a column energy of a column of said transformed channel tune matrix based on a plurality of rows of said transformed channel tune matrix, a plurality of elements of said transformed channel tune matrix with respect to said column, and said number of columns, obtaining of a rank of said column based on a plurality of column energies associated with a plurality of columns of said transformed channel tune matrix, and computing of energy of said transformed channel tune matrix based on said plurality of columns of said transformed channel tune matrix, a plurality of weights associated with said plurality of columns of said transformed channel tune matrix, a plurality of ranks associated with said plurality of columns of said transformed channel tune matrix, and said number of filled elements.

11. The method of claim 9, wherein said method of computing energy of said abstract channel tune matrix further comprising: obtaining of a number of rows of said abstract channel tune matrix, obtaining of a number of columns of said abstract channel tune matrix, obtaining of a number of filled elements of said abstract channel tune matrix, computing of a column energy of a column of said abstract channel tune matrix based on a plurality of rows of said abstract channel tune matrix, a plurality of elements of said abstract channel tune matrix with respect to said column, and said number of columns, obtaining of a rank of said column based on a plurality of column energies associated with a plurality of columns of said abstract channel tune matrix, and computing of energy of said abstract channel tune matrix based on said plurality of columns of said abstract channel tune matrix, a plurality of weights associated with said plurality of columns of said abstract channel tune matrix, a plurality of ranks associated with said plurality of columns of said abstract channel tune matrix, and said number of filled elements.

12. The method of claim 5, wherein said method of de-abstracting further comprising: obtaining of said abstract channel tune matrix, obtaining of a channel tune matrix of said plurality of channel tune matrices, wherein said channel tune matrix is associated with said abstract channel tune matrix, obtaining of said locally optimized abstract channel tune matrix, obtaining of a first element of said abstract channel tune matrix, obtaining a second element of said locally optimized abstract channel tune matrix wherein said second element corresponds with said first element, computing of a delta as the absolute difference between said first element and said second element, computing of signofdelta as the difference between said second element and said first element, obtaining of a sub-matrix based on said channel tune matrix, wherein said sub-matrix corresponds with said first element, obtaining of a third element of said sub-matrix, computing of the value of a fourth element based on said third element, said delta, and said signofdelta, and making of said fourth element a part of said redistributed channel tune matrix.

13. The method of claim 4, wherein said method of performing of global analysis further comprising: obtaining of said plurality of locally analyzed channel tune matrices, obtaining of a global channel tune matrix, obtaining of an element of said global channel tune matrix, obtaining of a sequence of local elements based on said plurality of locally analyzed channel tune matrices, wherein each local element of said sequence corresponds with said element, predicting of a global element based on said sequence, assigning of said global element to said element of said global channel tune matrix, performing of local analysis of said global channel tune matrix resulting in said globally optimal channel tune matrix.

14. The method of claim 1, wherein said method of computing of said globally optimal program view matrix further comprising: performing of local analysis of each of said plurality of program view matrices to result in a plurality of locally analyzed program view matrices, and performing of global analysis based on said plurality of locally analyzed program view matrices to result in said globally optimal program view matrix.

15. The method of claim 14, wherein said method of performing local analysis further comprising: clearing of an element of a program view matrix of said plurality of program view matrices if the time duration associated with said element is less than a pre-defined threshold, determining of an abstract program view matrix based on said program view matrix, clearing of an element of said abstract program view matrix if the time duration associated with said element is less than a pre-defined threshold, performing of local optimization based on said abstract program view matrix resulting in a locally optimized abstract program view matrix, de-abstracting of said locally optimized abstract program view matrix resulting in a redistributed program view matrix, obtaining of a sub-matrix of said redistributed program view matrix, wherein said sub-matrix is based on a meta-slot of said plurality of meta-slots and a meta-program of said plurality of meta-programs, performing of local optimization based on said sub-matrix resulting in a locally optimized sub-matrix, and making of said locally optimized sub-matrix a part of a locally analyzed program view matrix of said plurality of locally analyzed program view matrices.

16. The method of claim 15, wherein said method of determining of said abstract program view matrix further comprising: obtaining of said program view matrix, obtaining of an abstract row index of said abstract program view matrix, obtaining of an abstract column index of said abstract program view matrix, obtaining of a plurality of row indices, wherein each row index of said plurality of row indices is associated with said abstract row index, obtaining of a plurality of column indices, wherein each column index of said plurality of column indices is associated with said abstract column index, computing of a sum of a plurality of elements of said program view matrix based on said plurality of row indices and said plurality of column indices, wherein each element of said plurality of elements is part of said program view matrix at an element row index and an element column index, wherein said element row index is part of said plurality of row indices and said element column index is part of said plurality of column indices, and making of said sum a part of said abstract program view matrix at said abstract row index and said abstract column index.

17. The method of claim 15, wherein said method of local optimization further comprising: obtaining of said abstract program view matrix, applying of transformation on said abstract program view matrix to result in a transformed program view matrix, computing of a view factor of said transformed program view matrix, and applying of a sequence of transformations on said transformed program view matrix by maximizing on said view factor, wherein said view factor is computed for each transformation of said sequence.

18. The method of claim 17, wherein said method of transformation further comprising: determining of a plurality of elements of said abstract program view matrix, wherein the value of each of said plurality of elements is less than a pre-defined threshold, determining of a g-neighbor strength for each of said plurality of elements, obtaining of a minimum element from said plurality of elements based on said value of each of said plurality of elements and g-neighbor strength of each of said plurality of elements, obtaining of a neighbor of said minimum element, wherein the value of said neighbor is the lowest among the neighbors of said minimum element, adding of the value of said minimum element to said neighbor, and clearing of said minimum element.

19. The method of claim 17, wherein said method of computing a view factor further comprising: obtaining of said transformed program view matrix, computing energy associated with said transformed program view matrix resulting in a first component, obtaining of an abstract program view matrix based on said transformed program view matrix, computing of energy associated with said abstract program view matrix resulting in a second component, and computing of said view factor based on said first component and said second component.

20. The method of claim 19, wherein said method of computing energy of said transformed program view matrix further comprising: obtaining of a number of rows of said transformed program view matrix, obtaining of a number of columns of said transformed program view matrix, obtaining of a number of filled elements of said transformed program view matrix, computing of a column energy of a column of said transformed program view matrix based on a plurality of rows of said transformed program view matrix, a plurality of elements of said transformed program view matrix with respect to said column, and said number of columns, obtaining of a rank of said column based on a plurality of column energies associated with a plurality of columns of said transformed program view matrix, and computing of energy of said transformed program view matrix based on said plurality of columns of said transformed program view matrix, a plurality of weights associated with said plurality of columns of said transformed program view matrix, a plurality of ranks associated with said plurality of columns of said transformed program view matrix, and said number of filled elements.

21. The method of claim 9, wherein said method of computing energy of said abstract program view matrix further comprising: obtaining of a number of rows of said abstract program view matrix, obtaining of a number of columns of said abstract program view matrix, obtaining of a number of filled elements of said abstract program view matrix, computing of a column energy of a column of said abstract program view matrix based on a plurality of rows of said abstract program view matrix, a plurality of elements of said abstract program view matrix with respect to said column, and said number of columns, obtaining of a rank of said column based on a plurality of column energies associated with a plurality of columns of said abstract program view matrix, and computing of energy of said abstract program view matrix based on said plurality of columns of said abstract program view matrix, a plurality of weights associated with said plurality of columns of said abstract program view matrix, a plurality of ranks associated with said plurality of columns of said abstract matrix, and said number of filled elements.

22. The method of claim 15, wherein said method of de-abstracting further comprising: obtaining of said abstract program view matrix, obtaining of a program view matrix of said plurality of program view matrices, wherein said program view matrix is associated with said abstract program view matrix, obtaining of said locally optimized abstract program view matrix, obtaining of a first element of said abstract program view matrix, obtaining a second element of said locally optimized abstract program view matrix wherein said second element corresponds with said first element, computing of a delta as the absolute difference between said first element and said second element, computing of signofdelta as the difference between said second element and said first element, obtaining of a sub-matrix based on said channel tune matrix, wherein said sub-matrix corresponds with said first element, obtaining of a third element of said sub-matrix, computing of the value of a fourth element based on said third element, said delta, and said signofdelta, and making of said fourth element a part of said redistributed program view matrix.

23. The method of claim 14, wherein said method of performing of global analysis further comprising: obtaining of said plurality of locally analyzed program view matrices, obtaining of a global program view matrix, obtaining of an element of said global program view matrix, obtaining of a sequence of local elements based on said plurality of locally analyzed program view matrices, wherein each local element of said sequence corresponds with said element, predicting of a global element based on said sequence, assigning of said global element to said element of said global program view matrix, performing of local analysis of said global program view matrix resulting in said globally optimal program view matrix.

24. The method of claim 1, wherein said method of computing said plurality of plurality of selected channel-program pairs further comprising: obtaining of said globally optimal channel tune matrix, obtaining of said globally optimal program view matrix, obtaining of a slot of said plurality of slots, determining of a plurality of channels tuned based on said globally optimal channel tune matrix and said slot, wherein each channel tuned of said plurality of channels tuned is associated with a duration, computing of a weight associated with a channel tuned of said plurality of channels tuned based on a duration, wherein said duration is associated with said channel tuned, and a weight associated with a channel of said plurality of channels, wherein said channel corresponds with said channel tuned, determining of a plurality of programs viewed based on said globally optimal program view matrix and said slot, wherein each program viewed of said plurality of programs viewed is associated with a duration, computing of a weight associated with a program viewed of said plurality of programs viewed based on a duration, wherein said duration is associated with said program viewed, and a weight associated with a program of said plurality of programs, wherein said program corresponds with said program viewed, forming of a plurality of channel-program pairs, wherein a channel of a channel-program pair of said plurality of channel-program pairs corresponds with a channel tuned of said plurality of said channels tuned, and a program of a channel-program of pair of said plurality of channel-program pairs corresponds with a program viewed of said plurality of programs viewed, computing of a weight associated with a channel-program pair of said plurality of channel-program pairs based on a weight associated with a channel tuned of said plurality of channels tuned, wherein said channel tuned corresponds with a channel of said channel-program pairs, and a weight associated with a program viewed of said plurality of programs viewed, wherein said program viewed corresponds with a program of said channel-program pairs, ordering of said plurality of channel-program pairs based on said weight associated with each channel-program pairs of said plurality of channel-program pairs, selecting a pre-defined number of channel-program pairs resulting in a plurality of selected channel-program pairs, and making of said plurality of selected channel-program pairs a part of said plurality of plurality of selected channel-program pairs.

25. The method of claim 1, wherein said method of computing said plurality of plurality of adapted channel-program pairs further comprising: obtaining of a slot of said plurality of slots, obtaining of a plurality of selected channel-program pairs of said plurality of plurality of selected channel-program pairs, wherein said plurality of selected channel-program pairs corresponds with said slot, determining a plurality of previous slots, wherein each of said plurality of previous slots is a part of said plurality of slots and is earlier than said slot, obtaining of a plurality of plurality of predicted channel-program pairs based on said plurality of plurality of selected channel-program pairs, wherein said plurality of plurality of predicted channel-program pairs corresponds with said plurality of previous slots, obtaining of a plurality of plurality of actual channel-program pairs based on said past session data, wherein said plurality of plurality of actual channel-program pairs corresponds with said plurality of previous slots, predicting of a prediction error based on a plurality of errors, wherein an error of said plurality of errors is based on the error associated with a plurality of predicted channel-program pairs of said plurality of plurality of predicted channel-program pairs and a plurality of actual channel-program pairs of said plurality of plurality of actual channel-program pairs, wherein said plurality of actual channel program pairs corresponds with said plurality of predicted channel-program pairs, computing of a plurality of modified channel-program pairs based on said plurality of selected channel-program pairs and said prediction error, and making of said plurality of modified channel-program pairs a part of said plurality of plurality of adapted channel-program pairs.
